(19) United States
(12) Patent Application Publication
(10) Pub. No.: US 2024/0249190 A1
(43) Pub. Date: Jul. 25, 2024

(54) GRADIENT COMPUTATION IN HYBRID DIGITALLY TIED ANALOG BLOCKS WITH ARBITRARY CONNECTIVITY BY EQUILIBRIUM PROPAGATION

(71) Applicant: Rain Neuromorphics Inc., San Francisco, CA (US)

(72) Inventor: Maxence Rodolphe Pierre-Louis Ernoult, Paris (FR)

(21) Appl. No.: 18/416,773

(22) Filed: Jan. 18, 2024

Related U.S. Application Data
(60) Provisional application No. 63/456,775, filed on Apr. 3, 2023.

(30) Foreign Application Priority Data
Jan. 19, 2023 (FR) 2300524

(51) Int. Cl. G06N 20/00

(52) U.S. Cl. CPC G06N 20/00

(57) ABSTRACT

A learning system is described. The learning system includes analog compute blocks and analog-digital-analog (ADA) compute blocks. The ADA compute blocks are interleaved with the analog compute blocks. An ADA compute block includes an analog-to-digital converter, a digital compute unit, and a digital-to-analog converter.

### CROSS REFERENCE TO OTHER APPLICATIONS

This application claims priority to U.S. Provisional Patent Application No. 63/456,775 entitled GRADIENT COMPUTATION IN HYBRID DIGITALLY TIED ANALOG BLOCKS WITH ARBITRARY CONNECTIVITY BY EQUILIBRIUM PROPAGATION filed Apr. 3, 2023 and French Provisional Patent Application No. 2300524 entitled GRADIENT COMPUTATION IN HYBRID DIGITALLY TIED ANALOG BLOCKS WITH ARBITRARY CONNECTIVITY BY EQUILIBRIUM PROPAGATION filed Jan. 19, 2023, both of which are incorporated herein by reference for all purposes.

### BACKGROUND OF THE INVENTION

One of the biggest challenges in artificial intelligence (AI) training at the edge with analog devices is the ability to tile multiple analog layers to form “deep” analog neural networks. Deep analog neural networks allow the analog physics of the system to be leveraged both for inference and gradient computation. In such systems, voltage nodes or currents and resistive devices form physical artificial neurons and synapses. Equilibrium Propagation (EP) is an algorithm usable to compute error gradients in such analog systems.

However, tiling an arbitrary number of analog layers is extremely difficult to achieve. For analog circuits, the impact of noise and circuit instability grows dramatically with the number of analog layers being stacked. Thus, a deep analog neural network may have significant instability and noise. Therefore, given the current state of analog technologies, the scalability of fully analog system training is highly uncertain in the near-future and is heavily dependent on developments analog tiling.

At the other end of the technological spectrum are digital technologies. Some digital technologies are used in deep learning networks. For example, “digital in-memory-compute” (DIMC) systems embed memory at the core of digital computation. DIMC is much more technologically mature than analog systems in the context of deep learning networks. Yet, fully DIMC systems might be considerably more energy consuming than fully analog counterparts. Further, development of DIMC systems is currently dominated by a few large organizations. Moreover, the use of fully DIMC systems may not comport with the EP framework because DIMC computing units are unidirectional and, therefore, not energy-based, as called for by EP. Consequently, other techniques for improving deep learning are desired.

### BRIEF DESCRIPTION OF THE DRAWINGS

Various embodiments of the invention are disclosed in the following detailed description and the accompanying drawings.

FIG. 1 is a diagram depicting an embodiment of a system including digitally tied analog blocks as compared to fully digital and fully analog systems.

FIG. 2 depicts an embodiment of a flow associated with the forward pass.

FIGS. 3-6 depict embodiments of flows for training.

FIG. 7 depicts an embodiment of a flow associated with the backward pass.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A learning system is described. The learning system includes analog compute blocks and analog-digital-analog (ADA) compute blocks. The ADA compute blocks are interleaved with the analog compute blocks. An ADA compute block includes an analog-to-digital converter, a digital compute unit, and a digital-to-analog converter.

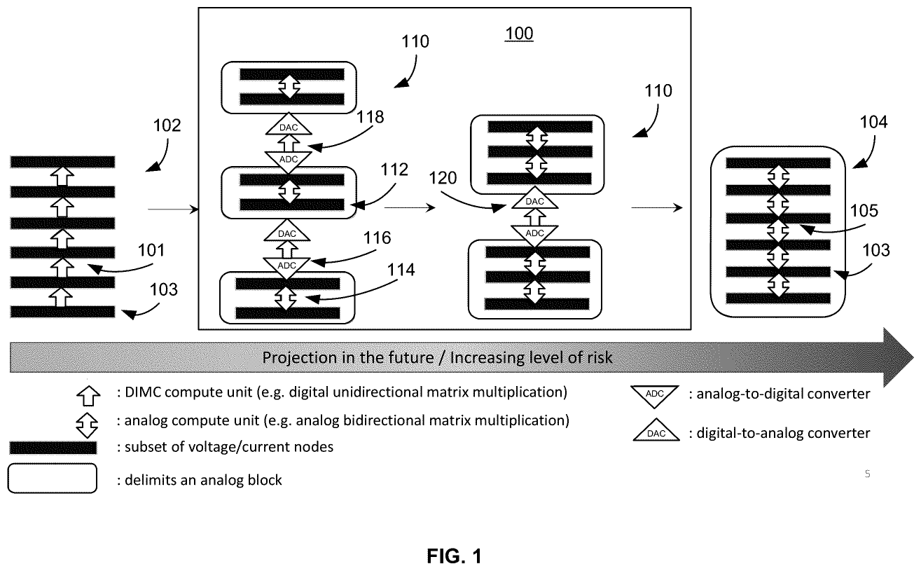

FIG. 1 is a diagram depicting an embodiment of system 100 including digitally tied analog blocks as compared to fully digital systems 102 and fully analog systems 104 that may be used with deep learning networks. Fully digital systems 102 include digital in-memory-compute (DIMC) units 101 interleaved with voltage and/or current nodes. Fully digital systems 102 are available in the short term, include mature technologies, and have little risk in implementation. However, fully digital systems 102 may consume more energy than fully analog system 104 and are dominated by a few large organizations. Fully analog systems 104 include analog compute units 105 (e.g. analog bidirectional matrix multiplication units) interleaved with voltage and/or current nodes 103. Fully analog systems 104 may be appropriate for use with equilibrium propagation (EP) and may consume significantly less energy than fully digital systems. However, current fully analog systems 104 may be subject to noise and instability and are not mature technology. Consequently, implementation of fully analog systems 102 for deep learning may carry significant risk.

System 100 includes multiple sets 110 of digitally tied analog blocks. Each analog block includes subsets of voltage/current nodes 114 (of which only one is labeled) mixed with analog compute units 114 (of which only one is labeled). In some embodiments, voltage/current nodes 112 are interleaved with analog compute units 114. Sets of analog blocks are separated by analog-digital-analog compute blocks. An analog-digital-analog compute block includes an analog-to-digital converter (ADC), a digital compute unit 118, and a digital-to-analog converter (DAC) 120. Thus, between analog compute blocks, the output is converted to digital format by ADC 116, undergoes processing by digital compute unit 118, is converted back to analog format by DAC 120, and is provided to the next analog block (if any). As a result, the analog compute block may be considered to be digitally tied. In some embodiments, fewer sets of nodes 112 are mixed with analog computer blocks 114. Although particular numbers of nodes 112, analog compute units 114, ADCs 116, digital compute blocks 118, DACs 120, analog compute blocks, analog-digital-analog compute blocks, and sets 110 of digitally tied analog blocks are shown, another number of one or more of these components may be present.

Thus a hybrid digital and analog architecture is used. Instead of considering fully digital or fully analog systems, hybrid systems made up of blocks of (bi-directional/energy-based) analog layers interconnected with (unidirectional/feedforward) digital layers with analog-to-digital (ADC) or digital-to-analog (DAC) converters in between are used. From a theoretical/machine learning point of view, such a system can be regarded as a model being energy-based by parts, wherein each energy-based submodels are interconnected with feedforward layers, with quantization modules in between.

This architecture offers a technological development paradigm/roadmap whereby one could smoothly transition between fully DIMC systems to fully analog systems by increasing the number of analog layers within each analog block, as analog tiling improves over time. Different releases/generations of the technology would correspond to a different number of analog layers within each analog subblock. The architecture of system 100 may be used in connection with deep learning models, implicit models, energy-based models, analog and/or digital architecture, gradient computation techniques in energy-based models, gradient computation techniques in feedforward models, and/or quantization techniques.

The architecture disclosed herein and depicted in FIG. 1 is very general. In some embodiments, as it assumes any connectivity pattern between the analog blocks in at least some embodiments. Owing to the generality of the architecture, it may cover different learning paradigms, including but not limited to: supervised, unsupervised and self-supervised learning, greedy block-wise learning. This architecture, although not fully analog/energy-based, may be exactly trainable by EP, end-to-end. While the strict application of the EP in such architectures may require access to the transpose of the feedforward weights interconnecting the blocks (entailing “weight transport”), any heuristic obviating weight transport may be applicable, e.g. Feedback Alignment and variants thereof. In some embodiments, any quantization scheme for ADC connections is applicable.

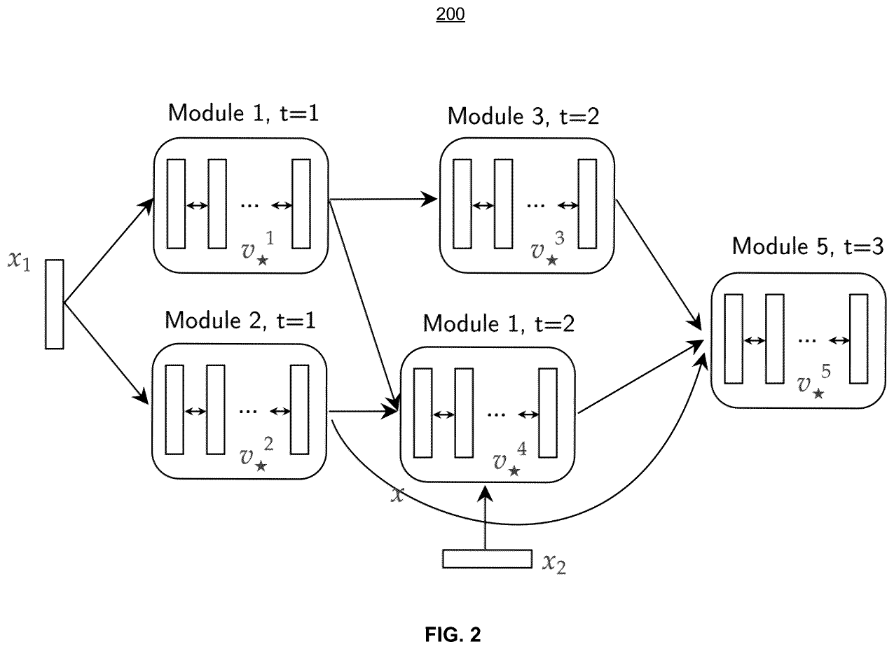

FIG. 2 depicts an embodiment of flow 200 associated with the forward pass. The module connectivity pattern may be defined by a Direct Acyclic Graph (DAG) G=(V, E) whose vertices are tuples (module k, time n) indicating when each module is employed and edges the digital feedforward connection between two modules. The DAG directly encodes the computational flow. Each module k is fully defined by a vector of state vk and is parametrized by Ok through an energy function Eₖ. Denoting S(G) the source nodes of the DAG (i.e. nodes without parents), the inference procedure can be exactly defined through the following chain of computation:

$$∀ k ∈ 𝒮 ( G ) , {υ}_{★}^{k} : {\partial }_{{υ}^{k}} {E}_{k} ( {x}^{k} , {υ}_{★}^{k} , {Θ}^{k} ) = 0 ,$$

$$∀ k ∈ V ( G ) \backslash 𝒮 ( G ) : {υ}_{★}^{k} : {\partial }_{{υ}^{k}} {E}_{k} ( {x}^{k} , {υ}_{★}^{k} , \{ {υ}_{★}^{l} , l ∈ 𝒫 ( k ) \} {Θ}^{k} ) = 0 ,$$

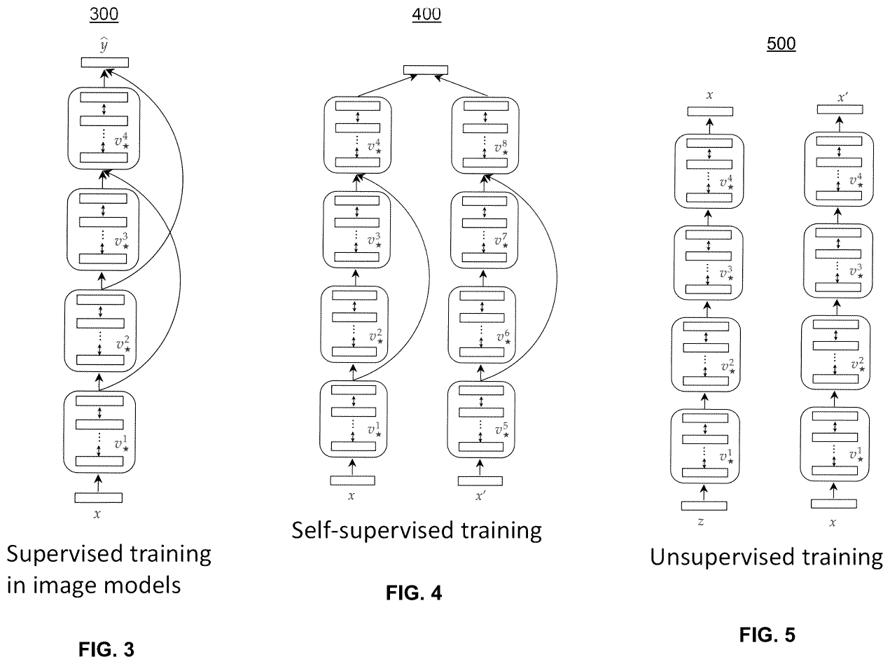

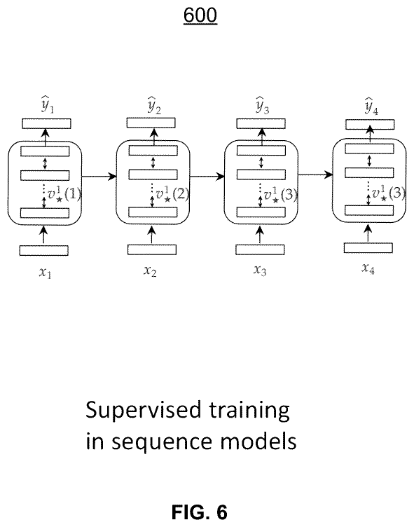

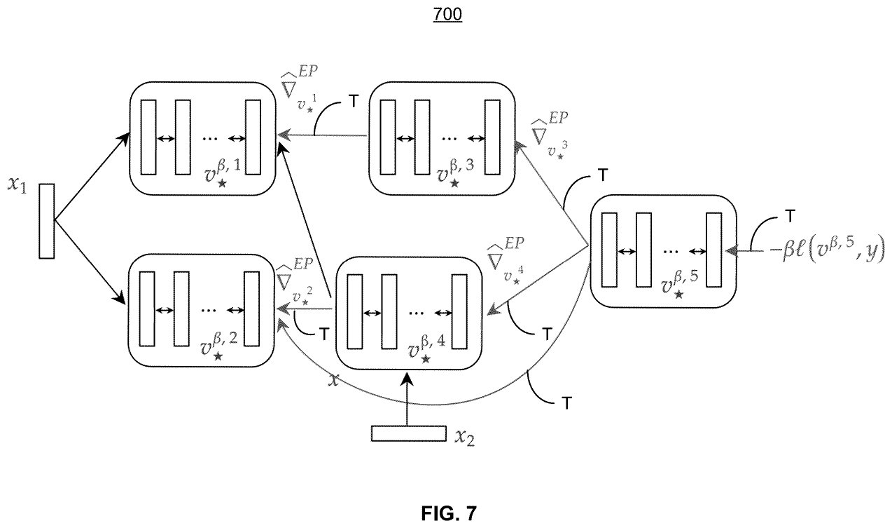

The reason one vertex of the DAG is not the module index only but the module index AND the time index indicating when it is executed is to allow for module re-use throughout the computation while preserving the DAG structure. FIGS. 3-6 depict embodiments of flows 300, 400, 500, and 600, respectively, for training.

FIG. 7 depicts an embodiment of flow 700 associated with the backward pass. Each terminal blocks, denoted as T(G), has a loss, which may depend or not on a label (whether we are in a supervised setting or not) defined as:

$$∀ K ∈ 𝒯 ( G ) , L = ℓ ( {υ}_{★}^{K} , {y}^{K} ) .$$

Then, the terminal blocks are nudged until the following steady state condition is satisfied:

$$∀ K ∈ 𝒯 ( G ) , {υ}_{★}^{K} : {\partial }_{{υ}^{K}} {E}_{K} ( {υ}^{K , β} , \{ {υ}_{★}^{l} , l ∈ 𝒫 ( K ) \} ) + β {\partial }_{{υ}^{K}} ℓ ( {υ}_{★}^{K , β} , {y}^{K} ) = 0 ,$$

With the subsequent parameters gradient of the terminal blocks given by:

$$∀ θ ∈ {Θ}^{K} : {\hat{∇}}_{θ}^{EP} = {d}_{β} ( {\partial }_{θ} {E}_{K} ( {υ}_{★}^{K , β} , \{ {υ}_{★}^{l} , l ∈ 𝒫 ( K ) \} , {Θ}^{K} ) ) {\vert}_{β = 0}$$

To perform the backward pass through the parent modules of the terminal blocks, we compute the error gradient with respect to the inputs of the terminal blocks, which shall be subsequently used as the error current to nudge the parent modules of the terminal blocks. The error current given by module K into module I can be computed as:

$$∀ l ∈ 𝒫 ( K ) , {\hat{∇}}_{{υ}_{★}^{K} \to {υ}_{★}^{l}}^{EP} = {d}_{β} ( {\partial }_{{υ}^{l}} {E}_{K} ( {υ}_{★}^{K , β} , \{ {υ}_{★}^{l} , l ∈ 𝒫 ( K ) \} , {Θ}^{K} ) ) {\vert}_{β = 0}$$

As such, the backward pass through each of the module k in the graph can be applied recursively through the following recursive equations:

$$∀ k ∈ V ( G ) \backslash 𝒯 ( G ) , {υ}_{★}^{k , β} : {\partial }_{{υ}^{k}} {E}_{k} ( {υ}_{★}^{k , β} , \{ {υ}_{★}^{l} , l ∈ 𝒫 ( k ) \} ) + β {\hat{∇}}_{{υ}_{★}^{k}}^{EP} + β {\partial }_{{υ}^{k}} ℓ ( {υ}_{★}^{k , β} , {y}^{k} ) = 0 ,$$

$${\hat{∇}}_{{υ}_{★}^{k}}^{EP} := {\sum }_{l ∈ Child ( k )} {\hat{∇}}_{{υ}_{★}^{k} \to {υ}_{★}^{l}}^{EP}$$

$$∀ θ ∈ {Θ}^{k} , {\hat{∇}}_{θ}^{EP} = {d}_{β} ( {\partial }_{θ} {E}_{k} ( {υ}_{★}^{k , β} , \{ {υ}_{★}^{l} , l ∈ 𝒫 ( k ) \} , {Θ}^{k} ) ) {\vert}_{β = 0}$$

$$∀ l ∈ 𝒫 ( k ) , {\hat{∇}}_{{υ}_{★}^{k} \to {υ}_{★}^{l}}^{EP} = {d}_{β} ( {\partial }_{{υ}^{l}} {E}_{k} ( {υ}_{★}^{k , β} , \{ {υ}_{★}^{l} , l ∈ 𝒫 ( k ) \} , {Θ}^{K} ) ) {\vert}_{β = 0}$$

The backward pass 700 introduced before could also be applied block-wise in a greedy fashion. In this case, the backward pass may be applied to the block considered to be trained along with an auxiliary classifier and a local loss. This local loss may be either supervised (using datalabels) or self-supervised. The arrows labeled T in FIG. 7 involve the transpose of the corresponding weights. These could be replaced by extra feedback weights, and subsequent alignment techniques such as Feedback Alignment and variants thereof could be applied.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A learning system, comprising:
a plurality of analog compute blocks; and
a plurality of analog-digital-analog compute blocks interleaved with the plurality of analog compute blocks, an analog-digital-analog compute block including an analog-to-digital converter, a digital compute unit, and a digital-to-analog converter.

2. The system of claim 1, wherein an analog compute block includes a plurality of nodes coupled with at least one analog compute unit.

3. The system of claim 1, wherein the digital compute unit is a digital-in-memory-compute unit.
